(19) United States
(12) Patent Application Publication
(10) Pub. No.: US 2007/0198580 A1
(43) Pub. Date: Aug. 23, 2007

(54) Method for indirect representation and access in an object-oriented programming language

(76) Inventor: Alexandr Savinov, Sankt Augustin (DE)

Correspondence Address: ALEXANDR SAVINOV, WEHRFELDSTR. 9, SANKT AUGUSTIN, 53757, omitted

(21) Appl. No.: 11/555,364

(22) Filed: Nov. 1, 2006

(30) Foreign Application Priority Data
Feb. 7, 2006 (EP) 06101389

(51) Int. Cl. G06F 17/00

(52) U.S. Cl. 707/103 R

(57) ABSTRACT

A method is provided for indirect representation and access in an object-oriented programming language. The method is based on using a new programming construct, called concept, which is a pair consisting of one object class and one reference class. A concept-oriented program is described as a hierarchy of concepts where each concept has one parent concept. Concepts in such a program are used instead of conventional classes. An object is represented by means of its complex reference which is a sequence of reference segments. The reference class of a concept provides a special method of continuation which is intended to resolve this reference into a direct reference used to access the represented object The programmer uses indirectly represented objects as usual and all the intermediate functions needed for indirect representation and access are inserted automatically behind the scenes.

### FIELD OF THE INVENTION

The present invention relates generally to computer systems and object-oriented programming languages, and more specifically to representation and access in object-oriented programming languages.

### BACKGROUND OF THE INVENTION

The conventional approach to object-oriented programming (OOP) consists in declaring classes of objects and then creating instances of the classes which are stored in the program by using some default format of references. In order to access such an object it is necessary to specify a variable where its reference is stored and a target method to be executed. In such an approach the programmer does not have control over the reference format and operations executed in order to resolve its value. In other words, we do not know what data is actually stored in the default reference and we cannot influence what happens after a method is called and before this method starts executing. It is a responsibility of the compiler, interpreter or execution environment to provide an appropriate object representation format and implement all the necessary object access functionality. From the point of view of the programmer all objects in this case are accessed directly because it is not possible to intervene in this process and such system default (native) references are referred to as direct references.

For example, Table 1 contains source code of two Java classes: SourceClass (lines 101-108) and TargetClass (lines 109-116). A method of SourceClass creates an instance of TargetClass and stores its reference in a local variable (line 103). Then it calls a method of this new target object (line 105) and returns an integer result (line 106). An important property of this conventional object-oriented approach is that we do not know the internal format of the reference stored in variable targetObject (lines 103 and 105). We also have no idea what happens after the target method is called (line 105) and before its first line of code (line 112) starts executing. The issue is that the conventional object-oriented programming languages do not provide any mechanisms to change the intermediate operations executed behind the scenes when objects are being accessed. Thus we are not able to find out what object representation format and object access procedures are used.

TABLE 1
Representation and access in Java (prior art)

| | |
|---|---|
| 101 | public class SourceClass { |
| 102 | public int sourceMethod( ) { |
| 103 | TargetClass targetObject = new TargetClass( ); |
| 104 | int var = 0; |
| 105 | var = targetObject.targetMethod( ); |
| 106 | return var; |
| 107 | } |
| 108 | } |
| 109 | public class TargetClass { |
| 110 | int field; |
| 111 | public int targetMethod( ) { |
| 112 | int var = 5; |
| 113 | var += field; |
| 114 | return var; |
| 115 | } |
| 116 | } |

Such an approach where the programmer does not have to care about the object representation and access (ORA) functionality is a significant advantage over previous technologies. The existing object-oriented programming languages such as Java or C++ provide an almost complete illusion of direct (instant) access and hide all the peculiarities of the object representation format creating the impression that nothing happens after a method is called and its execution starts. The programmer has to only create an instance of a class, store its reference in a variable, field or parameter, and then he/she can call its methods even if the underlying mechanism of object representation and access is rather complex. The compiler, interpreter or execution environment is then responsible for the generation of references in some system default format as well as for carrying out all intermediate procedures which are necessary to access the object given its reference such as resolution and security checks.

However, such a direct (instant) access and hidden reference format used in prior art object-oriented programming languages is only a convenient illusion or abstraction, and the object representation and access (ORA) functionality does actually exist and is supported implicitly on different levels of the system architecture including hardware and software levels. For example, a memory handle used to represent objects in the C++ programming language is in fact a convention used to represent objects in the global heap. Each such memory handle indirectly represents a position in physical memory and each time the object is going to be accessed from the program, the memory manager executes some procedure at the operating system level. This procedure finds the real position of this object in physical memory, checks access permissions, loads the block into main memory from the swap file if necessary and updates the current state of the processor to point to this memory block. When access is finished this system procedure frees all the resources and updates the state of its data structures. It is important to emphasize that most of this ORA functionality is not controlled by the programmer at the level of the source code. For example, the programmer cannot specify what concrete permissions should be checked when an object is going to be accessed and how memory blocks are allocated in virtual memory. In source code the programmer specifies a reference along with some target method name and after that all necessary intermediate procedures are executed at the system level behind the scenes so we have an illusion of the method call being executed instantly without any indirection.

Java also does not disclose its structure of references and access procedures to the programmer. We can store/pass references in variables, fields or parameters and then call methods of the referenced object but we never know what happens just before the method starts and have no means to influence the access procedure and reference format. Instead, all the representation and access functionality is maintained by the Java Virtual Machine (JVM) at the level of its execution environment. For example, if we call a method given some reference then JVM has to find the memory handle, which corresponds to this reference value using some internal facilities such as a hash map or look up table. This may involve carrying out some additional tasks like access counting, security checks, swapping, garbage collection, etc. Then this memory handle is passed to the system memory manager which knows how to process it in order to access the physical memory as described in the previous paragraph. And again, here the programmer has an illusion of direct Java method call given a reference with unknown format.

The same mechanism is used in distributed programming where references have more complex structures and can be quite large in size because they need to store information about the target object's real position in the network. The access procedure needs to resolve such a complex reference and may involve complex network interactions using different communication protocols. For example, Java remote references and CORBA references allow the programmer to call methods of a remote object as if they were local methods. The programmer is unaware of the reference format provided by the execution environment or a library, and he/she does not know anything about the access procedure executed behind the scenes at the network layer. In the source code the programmer has to only specify a reference and some target method name and then the underlying ORA mechanism will do all the rest providing the illusion of direct access. However, just as in the previous examples the main problem is that the programmer does not have any means to influence this underlying representation and access layer, for example, by changing the format of references or intervening in the execution of remote methods.

Such a conventional approach is widely used in OOP and is a very convenient mechanism. Indeed, we are given some universal built-in object representation and access methods, which can be used everywhere in our program for all classes of objects. So what is wrong with this prior art approach, what are its disadvantages and why we need something different? Shortly, the main problem is its universality and the absence of convenient customization means. The problem is that typically there is only one ORA mechanism provided by the compiler, interpreter or execution environment and there may be a few ORA mechanisms provided by standard libraries (such as Remote Method Invocation in Java or CORBA).

For a relatively small program that is normally not a big issue and such an approach is very convenient and efficient because almost all the needs are covered by these standard ORA mechanisms. However, for larger object-oriented programs such an approach may be too restrictive. The main need here is that different types of objects may require different ORA mechanisms which are not provided by default but instead should be designed for each concrete class or a set of classes. For example, the standard memory manager is known to be very inefficient in processing a huge number of small objects which are frequently created and deleted. Hence they should be managed by some special kind of custom container designed precisely for this type of objects taking into account their specific properties. Some program objects may need to store additional information in their references. Large objects could be stored in blocks of memory loaded and discarded separately. Another example is where we would like to have objects stored in a hierarchical memory buffer with the references consisting of multiple segments each specifying a relative position in the hierarchy. For all these cases we need special ORA mechanisms that can be chosen for each individual target class. The existing conventional approaches do not allow us to implement ORA functionality in an object-oriented language by introducing our own custom format of references and using our own custom procedures for object access. In particular, we cannot replace the standard representation and access functions by our own procedures provided that the existing code where they are used remains the same. In other words, the existing approach does not allow us to develop an ORA mechanism as part of our program (rather than as part of some middleware or operating system). Therefore we need some language means for describing arbitrary references and custom access procedures.

How have these problems been traditionally solved in prior art computer programs? In particular, how can the programmer define an arbitrary format of references and intervene in the sequence of access? One common and widespread solution is that ORA functions are called manually when we need them to be executed. For example, each time we need to access an object in memory given its handle as a reference, the handle value has to be manually locked and resolved. After executing this auxiliary procedure the target method can be applied to the obtained direct pointer. When the target method is finished and control is returned to the source method we again manually call another auxiliary procedure unlocking the memory handle and freeing the object. In real world programs this intermediate code is much more complex and may well consist of hundreds and thousands of operators. Each target class may require its own type of intermediate processing for preparing the object and then finishing access. Furthermore all these intermediate actions have to be called manually and explicitly where they are needed depending on the type of object being accessed. One consequence of such a manual mechanism is that the programmer has to write one and the same code in many places of the program. In other words, each time we need to access some target object we have to write some code before and after this method call. With modern computer programs becoming increasingly long and complex this problem is becoming much more acute. If there are 1000 accesses to some object then each time we need to write the corresponding intermediate code (for example, locking and freeing the object). What is even worse, all this auxiliary code in numerous places of the program has to be updated each time we need to change our ORA functionality. Thus if something changes in the intermediate access procedure, for example, we set an additional flag before the object is accessed, then we need to update 1000 places in the source code by inserting a line where this flag is set.

For example, the source code in Table 2 is a modified version of the program in Table 1. Here we want to count the number of processes currently accessing objects of class TargetClass using two methods beginAccess (line 214) for incrementing access count and endAccess (line 215) for decrementing access count. However, in Java (and other existing object-oriented programming languages) we have to call these methods manually each time a method of target class is called. In our example auxiliary lines 205 and 207 wrap line 206 which is the target method invocation. If there are more target method calls from other source contexts then we still have to write this pair of intermediate wrapping methods manually. If later we would like to change the way how object accesses are counted we need to manually update all these locations in the source program. One goal of the present invention consists in automating such wrapping and hence simplifying programming because the intermediate code will be called automatically. In particular, using this invention it is enough to write only one line with the target method call (line 206) and all the intermediate code (lines 205 and 207) will be then chosen and called by the compiler implicitly. Using this invention it is possible to automatically insert lines 205 and 207 in all places where we need to access an object of class TargetClass because these objects will be represented and accessed indirectly. Indirection in this case means automatic and implicit wrapping of the target method call into auxiliary methods. The intermediate auxiliary methods are associated with custom references that can be defined in the program and server many different classes of objects.

TABLE 2
Access counting in Java (prior art)

| | |
|---|---|
| 201 | public class SourceClass { |
| 202 | public int sourceMethod( ) { |
| 203 | TargetClass targetObject = new TargetClass( ); |
| 204 | int var = 0; |
| 205 | targetObject.beginAccess( ); |
| 206 | var = targetObject.targetMethod( ); |
| 207 | targetObject.endAccess( ); |
| 208 | return var; |
| 209 | } |
| 210 | } |
| 211 | public class TargetClass { |
| 212 | int field; |
| 213 | int accessCount = 0; |
| 214 | public void beginAccess( ) { accessCount++; } |
| 215 | public void endAccess( ) { accessCount−−; } |
| 216 | public int targetMethod( ) { |
| 217 | int var = 5; |
| 218 | var += field; |
| 219 | return var; |
| 220 | } |
| 221 | } |

Another existing and widespread method for indirect representation and access consists in using proxies as intermediate classes of objects. A proxy is defined as a normal class and then is used in the program instead of the target class. If we need to create an instance of the target class then instead we create an instance of the proxy. All target variables then reference the proxy (intermediate) class instances and all method calls are intercepted by the proxy which then decides how to process the requests. Normally an incoming method call is dispatched further to the underlying (substituted) target class with some intermediate processing. The proxy class has to know what class it replaces, i.e., it is designed to replace one concrete target class. In particular, all methods of the target class have to be in one or another way available in the proxy, normally by implementing some common interface. For example, if we wanted to indirectly access objects of class TargetClass then we could define a proxy class TargetProxy with the same methods. This proxy should be then used instead of the target class in the program. This approach has the following disadvantages:
It is impossible to define a custom format of references because proxies are stored as usual by means of system default references.
It requires a great deal of manual support because the target class and its proxy have to be manually kept in a consistent state. For example, if we want to change parameters of some method then it has to be done in both classes.
It is even more difficult to define a nested sequence of proxies.
It is difficult to define generic proxies for serving many target classes. For example, we might want to develop some generic memory manager with its own format of references and buffer structure which can be then used for different classes of target objects in the program.

There also exist other possible patterns, which can be followed in order to implement one or another sort of intermediate operations and indirect representation in a programming language. For example, so called smart pointers can be used for automating intermediate functions in C++. Many programming languages provide macro pre-processors allowing code substitution that can be used to automate indirect representation and access. However, all prior art methods are rather specific techniques or patterns, and require significant efforts from the programmer to implement and maintain such a code. In summary, the existing methods for organizing representation and access in an object-oriented computer program impose severe limitations on the programmer because of the necessity to have manual control over the activation of these functions and their maintenance in the source code. It is thus apparent that there is a need in the art for a method for automating the process of defining and maintaining ORA functionality in object-oriented programming languages. In particular, there is a need in the art for a method for defining custom references with arbitrary format and custom access procedures. The present invention provides a method for indirect object representation and access and meets other needs in the art.

### SUMMARY OF THE INVENTION

The present invention provides a method for aiding a programmer in implementing functions of indirect object representation and access (ORA) as an integral part of the program written in an object-oriented programming language. This method is based on the assumption that these functions account for a great deal and even most of the system complexity. Therefore ORA functions have to be described just like any other functions of the program by using class methods in this very program or in a library. This means that for a program we have to be able to describe an arbitrary reference format and access procedure using the same, or a similar compatible, language that is used for the rest of the program (in the source form or as a library). In other words, ORA functions should be described in the same way as normal classes and business methods. However, in contrast to normal class methods, such functions have to be activated implicitly and automatically rather than called explicitly and manually. The general goal consists in retaining the illusion of direct (instant) access but having a possibility to develop special representation formats and access procedures. Custom intermediate ORA functionality is then triggered automatically and implicitly by the compiler, interpreter or execution environment whenever it is necessary to represent or access an indirectly represented object in the program.

How concretely objects need to be represented and accessed is specified declaratively in the definition of their classes. This information is then used by the compiler which wraps target objects in intermediate objects. In particular, if a target class has one declaration then all its numerous instances in the whole program will be represented and accessed in one way. But if it is declared in some other way then all its instances in the whole program or within some scope will be represented and accessed differently. An advantage is that by only changing the declaration parameters of a class we can automatically change how all its instances are represented and accessed throughout the program. All references will change the format and all method calls will change intermediate procedures into which they are implicitly wrapped. Another advantage is that all ORA functions are concentrated (modularized) in one place from where they (including all changes) are automatically injected into all appropriate locations in the program by the compiler, interpreter or execution environment.

It is supposed that the compiler, interpreter or execution environment using this invention can determine what format of reference and access procedure to use depending on the declaration of the target object class in the source code. Then all method calls of these target objects will always be wrapped in these automatically determined ORA procedures. Such automatically determined custom references replace system default (direct) references and each access is executed by means of some custom resolution procedure. For example, such a method could be used to replace native Java references by unique text strings, which are resolved automatically into the original (native) substituted Java reference each time the target object needs to be accessed. ORA functions can be written as part of the program or as a library. For the method it is important only that it is possible to determine what concrete ORA function to use for each object access.

In the present invention each type of object is as usual described by its object class which has a number of fields, methods and other conventional facilities. There may be different ways to describe classes in different languages and standards. For example, a class could be described using some conventional object-oriented programming language, in XML format, using a binary representation or some custom format. It is important only that such a class specification can be used as a template to instantiate its objects. The central idea of this invention consists in using a reference class which is described just like a normal object class but has a special role in the ORA mechanism. Reference classes also have fields, methods and other conventional facilities; however they are used to describe a format of references rather than objects. Thus, an object class is intended to describe a format and behaviour of objects while a reference class is intended to describe a format and behaviour of references used to represent objects. By defining different reference classes it is possible to introduce an arbitrary format of references for representing objects instead of or in addition to existing direct (native) references.

Instances of an object class are referred to as objects while instances of a reference class are referred to as references. An important difference between objects and references is that the former are passed-by-reference while the latter are passed-by-value. In other words, references do not have their own references and are passed and stored by copying their fields. The main purpose of a reference is to represent some object. State and methods of objects can be accessed only if there is a reference which represents this object. A program which is written using object classes and reference classes operates two types of elements at run time: objects and references.

An object class and a reference class are not used separately. Instead, in the described invention, they exist as a pair because objects need to be somehow represented. A pair of one object class and one reference class is referred to as a concept. Thus, a concept can be viewed as the conventional class as used in OOP with an additional reference class attached to it. If a reference class has not been specified for some concept or is empty then such a concept is equivalent to the normal class as used in OOP. Concept as a new programming construct allows the programmer to manage both conventional objects and references which are used to represent and access them. This new approach to programming where concepts are used instead of classes as a more general programming construct is referred to as concept-oriented programming (COP). In particular, concepts are used to declare types of variables, method parameters, fields and return values. Then these elements of the program can be used to call some methods in a usual manner by specifying variable name followed by method name. The main difference is that each such type is a concept rather than a class and hence it denotes a pair of one object class and one reference class. One important consequence (and design goal) is that these objects will be represented and accessed indirectly using some intermediate code provided by the reference class.

The next important mechanism used in the present invention is concept inclusion. This means that each concept is included in some parent concept by means of the special inclusion relation. Since concepts are defined as pairs of one object class and one reference class this relation is in the general case defined for two pairs of classes—a child pair and a parent pair. That is, one pair of object and reference classes (child concept) is included in another pair of object and reference classes (parent concept). For each parent concept it is possible to specify its own parent concept. A concept-oriented program is described as an inclusion hierarchy of concepts with one explicit or implicit root concept and some leaf concepts which do not have child concepts. In this inclusion hierarchy each concept declares its parent concept and may have several child concepts. If concepts do not have their reference class defined then inclusion relation is equivalent to inheritance as used in OOP.

Each concept in the concept-oriented program is characterized by some position in the inclusion hierarchy. This position is important for the present invention because it determines how objects of this concept will be represented and accessed at run-time. The main idea is that any object is represented and accessed by means of its parent concepts starting from the root and ending with this object concept. The concept hierarchy is analogous to a hierarchical space with an address system. The root represents the outer most space while each child concept represents some internal space. In order to reach any internal space it is necessary to start from the root and then intersect all intermediate borders. Here we see what we need references for. A reference can be used to represent a position of one object in the context of its parent object. Since references contain arbitrary data in the format defined by the programmer, such a representation is an internal convention. For example, a reference might contain one integer field and one double field. In order to get direct access to the represented object such a reference has to be resolved. The logic of reference resolution is implemented in a special method of the reference class, called continuation method. It is a special method because it is called automatically when an object needs to be accessed. The main goal of the continuation method consists in interpreting this reference and translating its state into the system default reference which can be then used for direct access to the underlying object.

A complete representation of an object consists of all references starting from the root concept and ending with this concept. Such a sequence of references is referred to as a complex reference. Each element in the complex reference is referred to as a reference segment. Thus each segment in a complex reference is a local address of the next object in the context of the previous object. In order to access an object using its complex reference it is necessary to resolve all its segments. The very first (high) segment belongs to the root concept. Therefore it does not need to be resolved and can be used to directly access the represented object. The second segment belongs to the child concept and needs to be resolved using its reference class continuation method. After that we start resolving the third segment of the complex reference using its own reference continuation method and so on till the last (low) segment which represents the target object. The resolved last segment can be then used to directly call the target method. Notice that this sequence of continuation method calls is executed automatically while the methods themselves are provided by the programmer. Thus one target method call in the source code results in a sequence of intermediate actions that are executed behind the scenes.

Complex references are analogous to a hierarchical coordinate system such as postal addresses. The first segment of a postal address is country name. The second segment identifies a city within the context of its country. The third segment represents a street within the context of one city while the fourth segment is house number within the context of one street. In order to access an object with such an address it is necessary to find (resolve) its country, then in the context of this country resolve the city segment, then in the context of this city resolve the street name and so on till the last segment which will represent the target object. Thus each reference segment is defined in the context of its parent object represented by the previous segment. And vice versa, each reference segment represents an object which is responsible for resolving the next segment.

The resolved parent objects are frequently accessed from child objects. In order to make such access more efficient and avoid their repeated resolution we propose to use a mechanism of context stack. Context stack consists of all resolved reference segments of the current target object being accessed. The idea is that the resolved segments can be stored for future use in the stack. In the very beginning when the target object is going to be accessed context stack is empty. The result of the resolution of the first segment is stored as the first element of the context stack while the resolved last segment is stored on the top as its last element. Context stack grows when the next segment is resolved and its result is pushed onto its top. The last element on the top of the stack represents the target object while its previous elements represent parent objects.

Table 3 contains a simple example consisting of two concepts which are declared using keyword ‘concept’. Concept A (lines 301-310) defines both the reference class (lines 302-306) and the object class (lines 307-310) declared using keywords ‘reference’ and ‘class’, respectively. This concept is included in the system default concept Root which is provided by the compiler. The reference class of concept A has one integer field (line 303) and one method (lines 304) which takes one parameter. Notice that both the parameter and the return value have a type declared as a concept. As a consequence they will contain some custom data according to the format of these concepts and their position in the concept inclusion hierarchy. In particular, it may well happen that objects of Concept2 are represented by references taking 123 bytes while references to objects of Concept3 take 456 bytes in memory. Yet it is still possible to use such variables as if they contained direct references. The reference class of concept A also defines its continuation method (line 305) which has a special treatment and provides the logic of reference resolution. In other words, the continuation method knows how to transform the integer field into the substituted direct reference. The object class of concept A contains one field referencing an object of Concept1 (line 308) and one method (line 309). However, this object class method has the same signature as that defined in the reference class. Such methods having the same signature but different definitions in the reference class and the object class are referred to as dual methods. Concept B is included in concept A (line 312) and hence its instances will be created in the context of A. The reference class of concept A has one double field (line 314) and the continuation method (line 315) defined. Its object class has one text field (line 318) and one business method (line 319).

TABLE 3
An example of concept definition

| | |
|---|---|
| 301 | concept A in Root |
| 302 | reference { // Reference class of concept A |
| 303 | int intField; |
| 304 | Concept2 myMethod(Concept 3 param) { ... } |
| 305 | void continue( ) { ... } // Continuation method |
| 306 | } |
| 307 | class { // Object class of concept A |
| 308 | Concept1 refField; |
| 309 | Concept2 myMethod(Concept 3 param) { ... } |
| 310 | } |
| 311 | |
| 312 | concept B in A // A is parent concept for B |
| 313 | reference { // Reference class of concept B |
| 314 | double dblField; |
| 315 | void continue( ) { ... } // Continuation method |
| 316 | } |
| 317 | class { // Object class of concept B |
| 318 | String name; |
| 319 | void someMethod( ) { ... } |
| 320 | } |

Below we provide a list of main terms which are specific to this invention:
Reference class is a class which is intended to describe structure and behavior of object identifiers.
Reference is an instance of a reference class. It is passed-by-value, that is, by copying its fields. References are intended to indirectly represent objects by substituting for some direct reference. References and reference classes are denoted by means of rounded rectangles with thick borders.
Object class is a normal class as used in OOP. In this invention object class is one constituent of a concept.
Object is an instance of an object class. It is passed-by-reference, that is, by copying its reference. Objects and object classes are denoted by means of rectangles with normal borders.
Concept is a combination of two classes consisting of one object class and one reference class. In figures concepts are denoted by means of dashed rectangles.
Direct reference is a system default (native) reference that is provided by the compiler or platform where the program is going to be used. The structure and behaviour of direct references cannot be changed from the programming language and they create the illusion of instant access to objects they represent. Direct references can be substituted by indirect references having some custom format defined by the reference class of some concept.
Inclusion relation is used to specify a parent concept for this concept. Child concept is shown below its parent concept in diagrams.
Continuation method is a special method of the reference class which is intended to resolve this reference by translating its field values into the direct reference which can be then used to directly access the object.
Dual methods have the same signature but different definitions in the object class and the reference class of a concept. Dual methods are used as usual by specifying their name and parameters.
Complex reference is a sequence of reference segments where each reference segment has a type of one reference class and each next reference segment belongs to a child concept of the previous reference segment. Complex references are used to represent objects in a hierarchical space. Complex reference is shown as a dotted rectangle surrounding several references ordered vertically.
Context stack is a data structure which stores resolved reference segments of a complex reference providing direct access to the represented objects. Context stack is shown as a dotted rectangle surrounding several direct references ordered horizontally.

### BRIEF DESCRIPTION OF THE DRAWINGS

FIG. 1A is a block diagram of representation and access mechanism in prior art systems.

FIG. 1B is a block diagram of representation and access mechanism according to the present invention.

FIG. 2 is a diagram showing a concept inclusion hierarchy where each concept has one parent concept and consists of one object class and one reference class.

FIG. 3 is a block diagram showing how objects are represented by complex references.

FIG. 4 is a sequence diagram for the reference resolution procedure using context stack.

FIG. 5 is a flowchart depicting a process of compilation of a concept-oriented program.

### DETAILED DESCRIPTION OF THE INVENTION

### Indirect Object Representation and Access

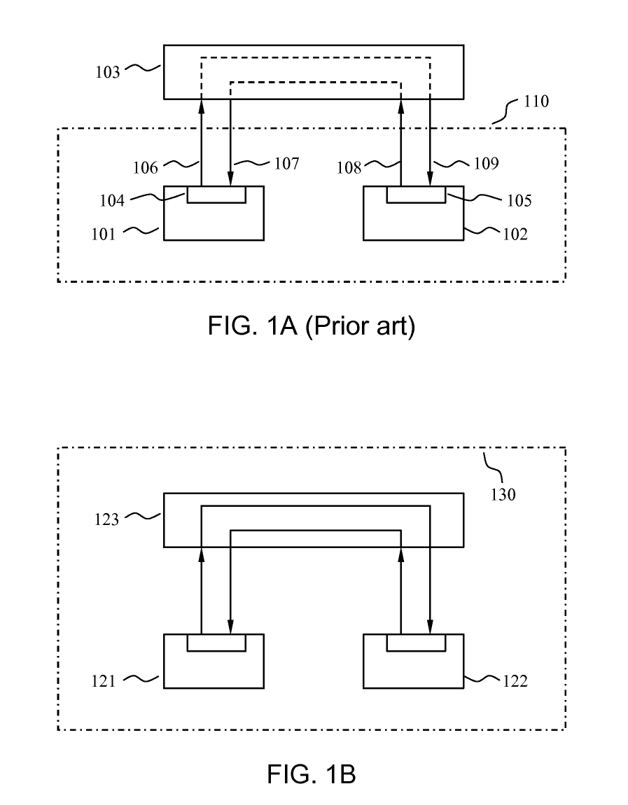

FIG. 1A shows a typical environment for implementing object representation and access (ORA) functionality in a computer program. It consists of a source object 101, a target object 102 and an intermediate object 103. The source object is executing some method 104 where it stores references to other objects in some format and needs to access them to get some response or to perform a task externally in the target context. In particular, the source object 101 may store a reference to the target object 102 and may need to access it by calling one of its methods 105. The target reference stored in the source object is an indirect representation of the target object and hence there has to be some intermediate object 103. Object 103 knows how to find target objects given their references and how to process access requests by calling target object methods. Intermediate object 103 receives an access request from 101 and then sends it to the target object 102 by calling its method 105. Each access request includes all information which is needed to execute it such as the target object reference, method name and method parameters. In addition to method calls there may be other types of access requests such as messages, event notifications or field read/writes. Each type of access request may require its own parameters to be passed to the intermediate object however all types of requests need the target object reference. Intermediate object 103 encapsulates the logic of representation and access specific to this mechanism while the target object 102 implements some final business methods to be called from outside. A method call in such an approach starts in the source object 101 and then proceeds to the intermediate object (path 106). Then this access request is processed within the intermediate object 103 where the reference is resolved and the target object is found. After that the request is passed to the resolved target object 102 (path 109) and the requested method 105 starts executing. When the target method finishes, control is returned to the intermediate object (path 108) which returns the result to the source object 101 (path 107).

It is important that prior art object-oriented programming languages do not provide any mechanism for explicit control over object representation and access in the program and this is why the intermediate object 103 is positioned outside the program 110. Each access request in this case leaves the program and is processed in the external software and/or hardware context. For the programmer there is an illusion that all access requests are processed instantly because after a method has been called its body starts executing immediately. At the same time the programmer has no means to influence or customize the provided default ORA mechanism 103 because it is separated from the program 110. In particular, it is not possible to provide a custom reference format or intermediate procedures to be executed during object access. For example, the C++ compiler provides its own format of object references which may depend on the platform and there is no easy way to adapt it to the needs of the program or to develop a new one by using this language. In Java there exists its own reference format which cannot be changed or replaced using this same language. In this case if we call a method of some class given a reference then control is immediately passed to the first statement of the target method. All intermediate actions are executed in JVM and are effectively hidden.

FIG. 1B shows a typical environment for implementing an ORA mechanism according to the present invention. The program 130 includes the intermediate object 123 as well as the source object 121 and the target object 122. In contrast to the prior art approach shown in FIG. 1A, here the intermediate object 123 and its methods are an integral part of the program 130 and hence can be written and controlled by the programmer. Thus this approach allows the programmer to describe his/her own intermediate objects and their special functions as part of the program or library and then use them automatically and implicitly. The purpose of the intermediate objects is to represent other objects and to provide access to them. In particular, it is possible to define a custom reference format and a custom access procedure which then will be automatically used in the program instead of the standard system facilities for all objects of the specified classes. It is important that all objects are still accessed as usual by specifying a reference and method with parameters in the source code. The difference is that now, using this invention, it is possible to specify a reference format and intermediate actions to be used implicitly and automatically. Thus each object is represented indirectly by using some custom reference format defined in the program instead of the default system reference. Object access is indirect because such custom reference must be resolved before an object method can be executed.

### Concept as a New Programming Construct

The proposed mechanism of indirect representation and access allows the programmer to describe an arbitrary format of references which are used to represent objects. The format of such custom references is described just like the format of objects by means of fields, methods and other facilities used in the conventional classes. For example, the format of a reference could be defined as an integer or as two fields with different purposes defined by the developer. Thus in the proposed mechanism of indirect ORA we distinguish two sorts of structure and behaviour templates—object classes and reference classes. The former are used to describe the structure and functions of conventional objects passed-by-reference where reference is a representative of the object. The latter are used to describe the structure and functions of references passed-by-value (that is by copying all the fields) and used to represent objects. Object classes are used in conventional object-oriented programming languages while reference classes are specific to this invention only. Instances of an object class are referred to as objects while instances of a reference class are referred to as references.

The main idea of the present invention is that object classes and reference classes are defined in pairs so that one reference class is associated with one object class. A pair consisting of one object class and one reference class is referred to as a concept. An approach to programming which uses concepts as the main programming construct instead of classes is referred to as concept-oriented programming. Normally concepts have a name although in some situations they could be anonymous. Variables, method parameters, return values and fields in a concept-oriented program are declared with the type specified as some concept name which is defined somewhere as a pair of one object class and one reference class. For example, in Table 3 a field (line 308) is defined as having a type of Concept1 where Concept1 is a concept name (not shown in this table).

Just as for a class declaration, there exist very different syntactic means for defining concepts. In the preferred embodiment of this invention a concept definition starts from keyword ‘concept’ followed by this concept name (line 301 for concept A and line 312 for concept B in Table 3). Then the concept needs to define its object class and reference class. A reference class starts from keyword ‘reference’ (line 302 and 313 for concepts A and B, respectively). An object class is distinguished by keyword ‘class’ (line 307 and 317 for concepts A and B, respectively). Both the object class and the reference class have a number of fields and methods. For example, concept A in Table 3 defines its reference class as consisting of one field (line 303) and one method (line 304). The object class of concept A consists of one field (line 308) and one method (line 309). A reference class can be empty and in this case its definition is optional. A concept with no reference class is equivalent to a normal class as used in OOP. It is also possible to define a concept with an empty object class.

Concepts are not used alone. Rather, each concept is included in some other concept, called the parent concept, using a so called inclusion relation. Thus, the whole program is not simply a set of isolated concepts but rather a hierarchy of concepts. In this hierarchy any concept has one parent (explicitly defined) and a number of children (not directly known from its declaration). We assume that the parent concept is specified via keyword ‘in’ followed by the concept name. For example, in Table 3 concept B (line 312) is included in concept A.

There exists a special concept provided by the compiler, interpreter or another kind of system environment by default, which is called Root. Normally functions specific to the root concept are provided as global procedures of the current execution environment or a library. Its reference class defines the format and behaviour of system default references used in the current environment. For example, in C++ the root concept is provided by the compiler and its format of references depends on the target platform for which the code is generated. In particular, such root references could be defined as 32 or 64 bit integers allocated by the operating system memory manager in the global heap. In Java, root references are allocated in Java format by the Java Virtual Machine. The root concept provides a kind of ultimate reference used to directly represent and access all objects in the program. This means that even if an object is represented indirectly using some custom reference format we need to restore somehow its root reference in order to access it. For example, an object could be represented indirectly via some text string (that is, this string is stored and passed as the object representative). However, if we need to execute any of its methods, read a field or otherwise access it, then it is necessary to resolve this text string into a system default reference in the format of the root concept.

Sometimes an underlying run-time environment provides more than one built-in representation and access mechanism. For example, it is frequently possible to allocate a new memory for an object either in a local heap or in the global heap. This means that there exist two types of standard root references with the corresponding access procedures. Hence there should be two root concepts. If we use some standard library then again it might provide different types of ORA mechanisms. For example, a library might provide managed objects which are automatically garbage collected, persistent objects which are automatically stored in a persistent store and remote objects which exist in the network. These three types of ORA mechanisms will be then available as three root concepts. Yet for simplicity below we will assume that there is only one implicit or explicit root concept.

Concept consists of two classes but the name is assigned to the whole concept as one construct. Creating a new instance of a concept results in creating two instances: one for the reference class and one for the object class. However, these two instances are created differently. The reference is created directly in the method where the instance has been created just like its local variables. Only the source method knows that a new instance of the reference class has been created. The object, on the other hand, is created in some storage such as main memory or database. Let us consider an example shown in Table 4. Here one concept is defined which describes a bank account (line 401). It consists of one reference class (lines 402-407) and one object class (lines 408-412) both consisting of some fields and methods. The reference class stores an account number (line 403) which is needed to access the account object so this field is an indirect representation of the account. Three other fields a defined for convenience in order to provide faster access to the account information. In particular, the reference simply copies the account opening date (line 404) and its balance (line 405) from the object it represents. We need also to remember the time when this balance was read (line 406) because the real balance stored in the account object may change while references representing this object will still store its old values. The object class has three fields for storing the date when this account was opened (line 409), the current balance (line 410) and a reference to the owner of this account (line 411). Notice that the opening date is stored in the object but it is also repeated in each reference to the account object (we assume that its value is constant). The balance is the latest balance and may change in time as a result of various transactions. However, references store its older values along with the timestamp when this value was read. An account owner is a reference and its format depends on how concept Owner is defined. For example, it may contain a field for storing social security number (SSN) of this person which provides access to the owner object.

TABLE 4
An example of concept creation

| | |
|---|---|
| 401 | concept Account |
| 402 | reference { // Instances will be created by value |
| 403 | String number; // Account identifier |
| 404 | Date openingDate; // Copy of the object field |
| 405 | double lastBalance; // Copy of last balance |
| 406 | Timestamp lastBalanceTime; // Time for last balance |
| 407 | } |
| 408 | class { // Instances will be created by reference |
| 409 | Date openingDate; // When this account was created |
| 410 | double balance; // Current balance |
| 411 | Owner owner; // A reference to the owner object |
| 412 | } |
| 413 | |
| 414 | void someMethod( ) { |
| 415 | ... |
| 416 | Account account = new Account( ); |
| 417 | ... |
| 418 | } |
| 419 | |
| 420 | < |
| 421 | “123456789” // number; |
| 422 | “01 Feb 2003” // openingDate; |
| 423 | 0.00 USD // lastBalance; |
| 424 | “01 Feb 2003, 10:01 am” // lastBalanceTime; |
| 425 | > |
| 426 | |
| 427 | < |
| 428 | “01 Feb 2003” // openingDate; |
| 429 | 5.00 USD // balance; |
| 430 | <SSN=234...> // owner; |
| 431 | > |

Let us now assume that some method in the program (lines 414-418) creates an instance of this concept (line 416). The creation procedure is expected to produce two instances: one reference and one object. The reference is stored in the local variable directly, i.e., this variable has actually four fields according to the format of the account reference class. An example of this reference is shown in Table 4, lines 420-425. In particular, this reference has a concrete account number assigned, an opening date, some initial balance and a timestamp for it. This reference exists locally and will be destroyed when this method returns. However, it can be passed-by-value to other methods via parameters or stored in object fields. Notice that the account reference does not include any direct (native) references so all accounts are known only by their number.

The creation procedure is also expected to produce a new account object somewhere in storage. An example of such an object is shown in Table 4, lines 427-431. It contains three fields including an opening date, balance and a reference to the account owner. Notice again, that the values of the reference are stored in the local variable directly because all references are passed and stored by value. The fields of the object are stored in some storage and can be accessed only using its reference. In particular, it is important to understand that if we change some field of the object then it does not influence its references. For example, if the balance changes then its existing references will still contain old values for it (this is why we stored a timestamp for the cached balance value). There is only one instance of the account but there are normally many instances of its reference which are copied between methods or stored in fields. For example, if a bonus has been added to the account after its creation then the account object balance will be 5.00 USD (line 429) while its reference will still have 0.00 USD (line 423) because it stores the initial balance at the time of creation.

Creating a concept instance results in creating a new reference which is stored in a local variable as a set of field values. The object is also normally created somewhere but it can be accessed only using this reference. Thus the local variable where a new reference is stored can be used to access state and functions of both the reference and the represented object. However, concepts may have two definitions for each method, called dual methods: one in the reference class and one in the object class. Consequently, when a method is applied to a reference it is not clear whether it belongs to the reference class or to the object class. In order to resolve this ambiguity we use the rule that any method applied to a reference always belongs to its reference class. Let us consider an example shown in Table 5 which adds some methods to the reference class and object class of the concept defined in Table 4. The reference class has one method for getting the last balance stored in this reference (line 508). In order to return a value stored in this reference we use keyword ‘this’. This keyword allows the programmer to refer to the current reference. In other words, a field name or method name which follows this keyword always means that of the reference class. This keyword can be used from methods of the object class to access the current reference associated with this object. For example, if a method of the account object needs to know its number stored in the reference then it has to use the following statement: this number. Simply field or method (without keyword ‘this’) is interpreted as belonging to the object class. For example, method getBalance of the reference class (line 509) calls the same method in its body however it does not use keyword ‘this’ and hence the method of the object class (line 516) will be called.

If some method in the program applies method getLastBalance to an account reference (line 522) then the last balance will be returned which is stored in this variable (0.00 USD for the example from Table 4, line 423). If then method getBalance is applied (line 523) to this variable then first the method of the reference will be called (line 509) which then delegates this request to the same object method (line 516). So finally we get the current balance of this account stored in the object (5.00 USD for the example from Table 4, line 429). Thus any method applied to a reference is that of the reference class so reference methods intercept all requests to the underlying object. However, they can delegate these requests to the represented object for further processing. In order to distinguish between reference methods from object methods keyword ‘this’ can be used or some other syntactically identifiable language construct could be used. If a reference method is not defined then some default behaviour can be activated. For example, the corresponding object method can be called.

TABLE 5
An example of method invocation

| | |
|---|---|
| 501 | concept Account |
| 502 | reference { |
| 503 | String number; |
| 504 | Date openingDate; |
| 505 | double lastBalance; |
| 506 | Timestamp lastBalanceTime; |
| 507 | |
| 508 | double getLastBalance( ) { this.lastBalance; } |
| 509 | double getBalance( ) { return getBalance( ); } |
| 510 | } |
| 511 | class { |
| 512 | Date openingDate; |
| 513 | double balance; |
| 514 | Owner owner; |
| 515 | |
| 516 | double getBalance( ) { return balance; } |
| 517 | } |
| 518 | |
| 519 | void someMethod( ) { |
| 520 | ... |
| 521 | Account account = new Account( ); |
| 522 | double last = account.getLastBalance( ); // = 0.00 |
| 523 | double current = account.getBalance( ); // = 5.00 |
| 524 | ... |
| 525 | } |

Reference methods are executed directly because reference is an element represented and passed by value. In other words, references do not have their own representatives and therefore their members are accessed directly. However, objects cannot be accessed directly because their location is unknown. Actually, an object can reside almost anywhere: in main memory, on disk or on another computer. For example, for an account we store account number in its reference which says nothing about the real object location. The question then is how can we access the state and behaviour of an object represented by its custom reference? In particular, if an object method is called from some reference method then how this object can be found? Shortly, this is performed by a special reference method, called continuation method. This method has a special role because it is called automatically whenever the object represented by this reference has to be accessed. The continuation method has to interpret the fields of the reference as the object indirect identifier and then translate them into the system default reference. This system default reference provides direct access to the object and can be used to access its state and behaviour. For example, the reference class of concept Account shown in Table 4 has one field (line 403) which is intended to identify account objects. In order to access an account it is necessary to somehow resolve this account number into its system default reference.

Let us consider an example shown in Table 6 which uses the same concept as in Table 5 but adds a definition for the continuation method in its reference class (lines 604-610). This method is normally called automatically by the compiler when it determines that there is the necessity to access an object of this concept. Essentially the main goal of this method consists in generating a direct reference to this object from the reference it is applied to. In this example it prints some message (line 605) and then translates the account number stored in a field of this reference (defined in Table 5, line 503) into a system default reference (line 606). There can be many ways how this resolution can be carried out but normally there is some mapping from the space of indirect identifiers to the space of direct system default references. Once a direct reference has been obtained it can be used for accessing the target object of this concept. In order to indicate the point where the resolved reference can be further used we simply call again the continuation method (line 607). The compiler determines that this method is applied to the direct reference which needs not to be resolved. Hence in this point (line 607) the target method can be executed. After the access to the object is finished the continuation method can make some clean up (line 608) and before it returns to the source context it prints a message (line 609).

TABLE 6
An example of the continuation method

| | |
|---|---|
| 601 | concept Account |
| 602 | reference { |
| 603 | ... // As in Table 5 |
| 604 | void continue( ) { |
| 605 | print(“ > Start resolving account ” + number); |
| 606 | Root root = resolve(number); // Resolve |
| 607 | root.continue( ); // Go to the object |
| 608 | unresolve(number); // Clean up |
| 609 | print(“ < End resolving account ” + number); |
| 610 | } |
| 611 | } |
| 612 | class { |
| 613 | ... // As in Table 5 |
| 614 | Owner getOwner( ) { |
| 615 | print(“ *** Execute object method”); |
| 616 | return owner; |
| 617 | } |
| 618 | } |
| 619 | |
| 620 | void someMethod( ) { |
| 621 | ... |
| 622 | Owner owner = account.getOwner( ); |
| 623 | ... |
| 624 | } |
| 625 | |
| 626 | $ > Start resolving account 123456789 |
| 627 | $ *** Execute object method |
| 628 | $ < End resolving account 123456789 |

Let us now assume that we need to get the owner of the account object represented by its reference in some method of the program (line 622). The reference class does not provide a definition for this method and hence the object method has to be called by default (lines 614-617). So the only problem consists in generating a direct reference to the account object given its indirect reference in the format of the reference class which contains some custom data including the account number. Here the compiler automatically calls the reference continuation method and only when it resolves the reference (line 607) the target method is called (line 614). Then this method call (line 622) produces the output shown in lines 626-628. Here we clearly see that the target method call is wrapped into an intermediate procedure. This intermediate procedure will be executed automatically whenever we need to access any object of concept Account. On the other hand, this approach retains the illusion of direct access because methods are used as usual by applying them to references. The advantage is that the compiler knows the format of all the references for all objects and resolves them automatically and transparently.

### Concept Inclusion and Complex References

Normally concepts are not used alone. Instead, each concept has a parent concept specified using a so called inclusion relation. This relation can be viewed as a generalization of the inheritance relation in OOP. Thus concepts live within an inclusion hierarchy where each concept has one parent and many children. If a concept does not declare its parent concept then it defaults to the root concept. Thus the root concept is a direct or indirect parent for all other concepts in the hierarchy. Declaration of the parent concept can be performed by means of keyword ‘in’ followed by the parent concept name as shown in Table 3, lines 301 and 312. Child concepts are supposed to describe more specific elements while parent concepts are more general.

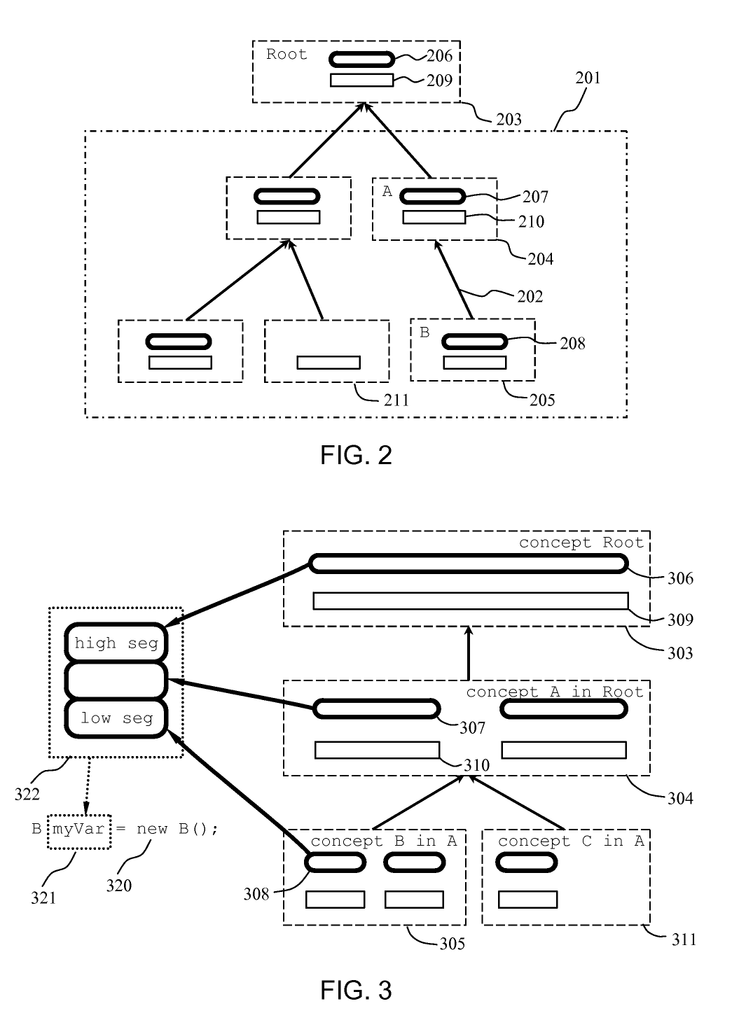

In FIG. 2 the source program 201 consists of a set of concepts connected with the inclusion relation denoted by upward arrows, for example, 202. Concepts 203, 204 and 205 correspond to concepts Root, A and B in the source code from Table 3. Each of these concepts is a pair of one object class (shown as a rectangle with normal border) and one reference class (shown as a rounded rectangle with thick border). Notice that concept 211 has only its object class while the reference class is empty and hence it is a conventional class. The root concept 203 is not part of the program 201 because it is provided by the compiler, interpreter or execution environment and is responsible for direct object representation and access. The root concept also has the default reference class 206 which is used to directly represent objects. For example, direct root references may have the format of memory handles allocated by the operating system or the format or Java references managed by JVM. It is important that the root concept provides basic ORA functionality which cannot be changed but can be extended by child concepts in the program. Concept 204 is included in the root concept 203, and concept 205 is included in concept 204 using inclusion relation 202.

Objects and references are two elements existing at run-time. This means that a concept-oriented program can create instances of reference classes and instances of object classes which are described within concepts. This allows the programmer to define an arbitrary format of references with their behaviour precisely as it is done for objects in OOP. At run time objects and references are created as a result of concept instantiation. References are stored in local variables while objects are stored in some storage. The format of references corresponds to the structure of reference classes used for their creation. However, if the concept specified as a type of the variable has parent concepts then this object will be represented using so called complex references, which consist of several segments corresponding to the parent concepts. A fully qualified complex reference starts from the root concept and proceeds to the target concept. The first (high) segment is of the root concept while the last (low) segment is of the concept declared as the type of the variable. Complex references may have shorter length and include only last segments. In this case object representation is not complete but they are more efficient and can be used if high segments are known. Local (short) references are used when the context is known or can be otherwise restored. An advantage of fully qualified references is that they have wider scope and can be used (resolved) from anywhere in the program. A disadvantage is that access on such references requires resolution of all intermediate objects represented by their segments. Local references have narrower scope but are more efficient because fewer segments have to be resolved.

In FIG. 3 the source program consists of concepts Root (303), A (304), B (305) and C (311) where each concept is included in the parent concept positioned over it. Each concept consists of its instances created at run time which are shown as reference-object pairs. The root concept has one reference 306 and one object 309. Concept A has two pairs of instances and one of them consists of reference 307 and object 310. Concepts B and C also have some instances each consisting of one reference and one object. It is important that such a structure has a hierarchical form where each reference-object pair has many child reference-object pairs. If a new instance of concept B has to be created (statement 320) in the program then the compiler takes into account that the target concept B is included in A which in turn is included in Root. Consequently variable myVar (321) will store not only a reference in the format of concept B but also all its parent references in the format provided by concepts A and Root. Such a complex reference (322) consists of three segments. The first (high) segment is instance 306 of the reference class of the root concept 303. The second segment is instance 307 of the reference class of concept A (304). And the last (low) segment is instance 308 of the reference class of concept B (305). All these three reference segments constitute one complex reference 322 which represents the new created object of concept B. This reference is stored in the local variable 321 and is passed-by-value as one element. Such a structure is analogous to the conventional postal address which represents the position of an element in a hierarchical space.

An important distinguishing feature of the described approach is that objects and references exist within a hierarchy at run time. For example, reference 307 and object 310 have parent reference 306 and object 309. Another important distinguishing feature is that different parts of one object exist separately. For example, the base part 309 has two extensions (child objects of concept A) and one of them is 310. These two parts 309 and 310 have their own representations and may have different locations in storage.

Each reference is created in the context of some object and only within this object it does have some meaning and can be interpreted as a representation of an object of this concept. For example, reference 307 has been created and exists in the context of object 309. The object where a reference has been created is referred to as its context. Many references can be created within one context. The references belonging to one context are interpreted as coordinates or positions within this object. For example, a city object may have many street names and hence different street names (references) exist in the context of one city object. And they can be interpreted only within this city context while in the context of other city objects they are meaningless. The current context is available in the program via keyword ‘super’. This means that if this keyword occurs in the source code, it points to the parent object and hence we can access the parent context state and behaviour. Using this keyword we can access the object where this reference has been created. Context plays a role of environment or container for references and frequently provides important data and functions to its child references and objects. An object may have many references in its context (of child concepts). Notice that for the present invention it is important that we distinguish between objects (such as city) and their references (such as city names).

Earlier it was defined that if a method is applied to a variable then the method of the reference class will be called while object methods can be then called from inside. What happens if a variable contains a complex reference consisting of several segments? In this case methods of the high segment have a priority and intercept such calls. In other words, if a method is applied to a variable containing a complex reference then the method of its first (high) segment will be called. After that this method can decide how to proceed. In particular, it can call some methods of its object and/or it can delegate this request to the next segment. The next segment then can perform some processing and again call the same or some other method of the next child segment and so on.

TABLE 7
Method interception

| | |
|---|---|
| 701 | concept Account |
| 702 | reference { |
| 703 | ... // As in Tables 5–6 |
| 704 | void doSomething( ) { |
| 705 | print(“> Start parent method.”); |
| 706 | sub.doSomething ( ); // Go to the child segment |
| 707 | print(“< End parent method.”); |
| 708 | } |
| 709 | } |
| 710 | class { ... } // As in Tables 5–6 |
| 711 | |
| 712 | concept SavingsAccount in Account |
| 713 | reference { |
| 714 | ... // Some fields and methods |
| 715 | void doSomething( ) { |
| 716 | print(“ > Start child method.”); |
| 717 | doSomething ( ); // Call this object method (723) |
| 718 | print(“ < End child method.”); |
| 719 | } |
| 720 | } |
| 721 | class { |
| 722 | ... // Some fields and methods |
| 723 | void doSomething( ) { |
| 724 | print(“ *** Child object method.”); |
| 725 | } |
| 726 | } |
| 727 | |
| 728 | void someMethod( ) { |
| 729 | ... |
| 730 | SavingsAccount savingsAccount = new SavingsAccount( ); |
| 731 | savingsAccount.doSomething( ); |
| 732 | ... |
| 733 | } |
| 734 | |
| 735 | $ > Start parent method. |
| 736 | $ > Start child method. |
| 737 | $ *** Child object method. |
| 738 | $ < End child method. |
| 739 | $ < End parent method. |

The source code in Table 7 consists of two concepts. Concept Account defines method doSomething in its reference class (lines 704-708). The same method doSomething is defined in the reference class of concept SavingsAccount (lines 715-719) which is included in concept Account. If this method is applied to a reference of concept SavingsAccount somewhere in the program (line 731) then the method of the parent concept Account intercepts this call. This method of the high segment (lines 704-708) will print some messages and then delegates this request to the child reference (line 706). In order to access the child reference (the next segment in the complex reference) we use keyword ‘sub’. This results in executing method doSomething of concept SavingsAccount (lines 715-719). This method of the child reference prints some messages and finally delegates the request to the object it represents (line 717) which simply prints a message (line 724). Thus one method call triggered rather complex intermediate actions described as part of parent concepts. The output produced by this method call (lines 735-739) demonstrates that the target method of the object class is wrapped in two reference methods which automatically intercepted this call. Intermediate methods of reference classes may contain any logic that must be executed for any access. For example, we might want to ensure that the target object is prepared for access or to guarantee that such an access is secure.

### Complex Reference Resolution

Each instance of a reference class is simply a set of fields defined by the programmer. For example, a reference could contain a text string or some integer values. In order to access an object given its reference the continuation method is used. This method is defined in the reference class and its goal consists in translating this reference into a root reference providing direct access to the object. If the object reference substitutes for a system default reference then the continuation method allows us to restore it at run time in order to get direct access to the object. In the preferred embodiment the continuation method takes no parameters and returns no values. The continuation method is used to automatically and transparently resolve instances of its reference class and get direct access to the represented object. This procedure is carried out each time it is necessary to access an indirectly represented object and it can be referred to as resolution on demand. One problem of this strategy is that normally methods have many requests to this or parent object. In this case any access requires potentially complex resolution and the efficiency can be rather low. For example, a method might call methods of its parent context which in turn use their own parent contexts and so on. Each such access results in a rather complex procedure described in the continuation method. In particular, the resolution will be carried out for each occurrence of keyword ‘super’, which provides access to the parent context.

In order to avoid such multiple repeated resolutions of the same segments of a complex reference this invention proposes to use a modified procedure of access where segments are resolved in advance and the result is stored for future use. The idea of this strategy is that we avoid repeated resolutions of the same reference segments by storing their resolved direct references in a special data structure called context stack. The context stack stores all parent contexts by using root references which can be used directly rather than resolving them again. An important feature is that the context stack is built as a preliminary operation before the object is used. As a result all objects represented by segments of the complex reference are directly accessible. In particular, this strategy guarantees that whenever the compiler meets keyword ‘super’ in the source code, this object is already resolved and its direct root reference is in the context stack.

The mechanism of the context stack uses the following sequence of access. Any object access starts from the resolution of the very first (high) segment and ends with the resolution of the last (low) segment which represents the target object. The resolution is carried out by means of the corresponding continuation methods. The very first element pushed on the context stack contains a direct reference to the first context, the second element is a direct reference to the second context and the last element on top of the context stack is a direct resolved reference to the last context which is the target object. Thus when we need to resolve the next segment or to executed its methods all of its parent contexts are already resolved and their direct references are stored on the context stack. When we use keyword ‘super’ in the program we can directly access the corresponding object using its resolved reference from the context stack (rather than via the continuation method). In particular, when we resolve the last segment representing the target object all of the parent segments are already resolved so this procedure can be executed much faster than by using the standard access strategy described in the previous sections (resolution on demand). The number of elements in the context stack is equal to the number of segments in the current complex reference.

The use of the mechanism of the context stack does not change how a concept-oriented program is written and executes. It simply makes its execution more efficient by increasing speed of access on complex references. This means that any access to parent objects is executed directly by retrieving their root references from the context stack rather than resolving them for each use on demand. In particular, each line of code where keyword ‘super’ is used will be executed directly without resolution in the case where the context stack is used, while without the context stack this keyword needs to be resolved for each access. In order to implement this mechanism the compiler, interpreter or execution environment has to provide all the necessary facilities including data structures and sequence of access. An important feature of using this mechanism is that higher segments are resolved before lower segments of the complex reference and the result of the resolution is stored in the context stack for future use from child objects.

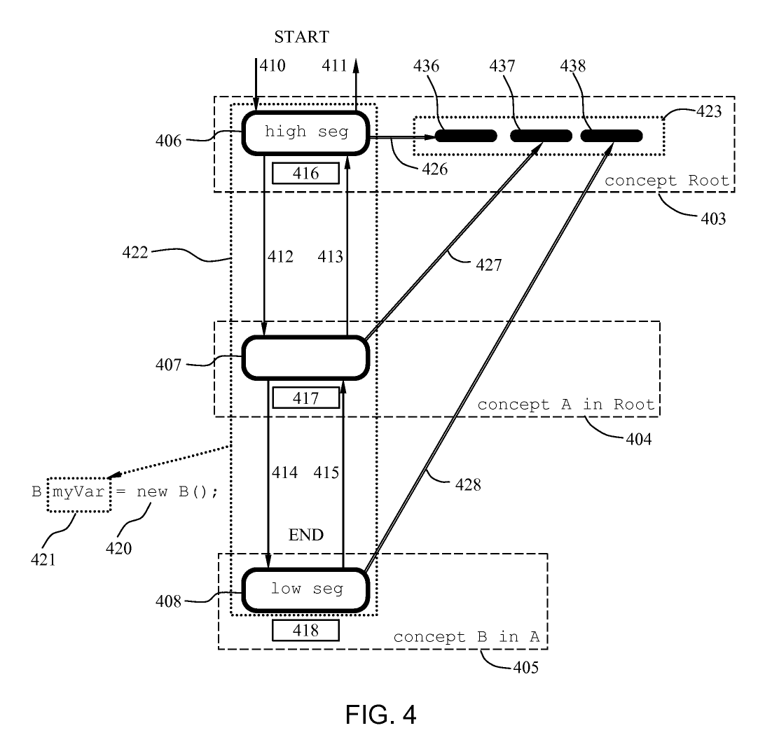

FIG. 4 shows the sequence of access to an object represented by a complex reference using the mechanism of the context stack. The program consists of three concepts Root (403), A (404) and B (405) where each next concept is included in the previous one (called an access sequence). In the program, variable 421 is defined as having concept B. This variable contains complex reference 422 which represents some object of concept B. This reference consists of three segments 406, 407 and 408 with the format defined by the reference classes from the access sequence. There exist also three objects 416, 417 and 418 represented by these three segments which have the format of their object classes. Thus reference 406 represents object 416, reference 407 indirectly represents object 417 and reference 408 indirectly represents object 418. It is assumed that this complex reference is used to call some method defined in the object class of concept B (405) and this method needs to access its contexts, i.e., parent objects 416 and 417.

If we were using a sequence of reference resolution described in the previous sections (resolution on demand) then we would start by resolving the last segment 408. However, implicitly, it would require resolving the parent segments 407 and 406 as soon as they are used from the target method or within the resolution procedure. In contrast, in the new access strategy based on the context stack we start access procedure explicitly from the very first (high) segment 406 of the complex reference before it is really needed and then proceed by resolving child segments down till the last segment 408 along the access sequence. The result of each resolution is stored in the context stack 423 which grows from left to right as the access proceeds and lower segments are resolved.

Let us consider this access strategy in more detail. The procedure starts by resolving the very first (high) segment 406 of the complex reference 422 via its continuation method between points 410 (enter) and 411 (exit). Since this segment is already in the system default format it does not need to be resolved and it is simply pushed (path 426) on the currently empty context stack 423 as its very first element 436. Element 436 of the stack is a direct reference to object 416.

On the next step the access procedure resolves the second segment 407 via its reference continuation method 412-413. This method processes the second segment 407 and pushes the obtained system default reference on the context stack as its new top element 437 (path 427). Here again, once this reference has been resolved, object 417 can be accessed directly without the need to resolve its reference 407 because its direct reference 437 is stored on the context stack. The third segment 408 is resolved in the same way (path 428) using the continuation method 414-415 of its reference class. The result of the resolution of the third segment is pushed on top of the context stack as element 438. After that the stack contains three direct references to the objects represented by three segments of the complex reference. Since there are only three segments the complex reference is completely resolved and the resolution procedure finishes. The top element 438 on the context stack is actually a direct reference to the target object 418 while other elements are direct references to its parent contexts 417 and 416. When the target object (and all its parents) has been resolved the access procedure can call its methods or otherwise access it. However, all the parent objects (contexts) and this object can be accessed directly without resolution. In the case of many such invocations of parent objects performance can increase significantly in comparison with the procedure described in the previous section where the context stack is not used (resolution on demand).

An example of the program demonstrating the described sequence of access is shown in Table 8 which is an extended version of the program shown in Table 7. It defines concept Account included in Root (line 801) and concept SavingsAccount included in Account (line 817). Concepts Account and SavingsAccount have their continuation methods defined in the reference classes and these methods will be called automatically whenever their objects need to be accessed. The context stack is maintained automatically by the compiler. The continuation method of concept Account (lines 804-809 prints a message when it starts (line 805) then resolves its reference (line 806) which is then used to continue the access procedure (line 807). Finally it again prints a message (line 808). Line 807 has a special role because here the resolved reference will be pushed on the context stack for future use and the access procedure proceeds. The continuation method of concept SavingsAccount is implemented similarly and simply resolves its reference (line 822) and then proceeds (line 823). In order to demonstrate the sequence of access the method prints two messages when it starts (line 821) and when it returns (line 824). Here we also do not show how the resolution is performed (method resolve is not defined) because there exist numerous algorithm for storing the mapping from the space of references to the space of system default references. Concept SavingsAccount defines a method in its object class (lines 829-833). For simplicity it is assumed that this method is not defined in this or parent reference classes so it will not be intercepted. This method is implemented in such a way that it makes two calls to its parent contexts (lines 831-832) but the resolution will be carried out only one time.

Methods of this program can create instances of concept SavingsAccount or get them as parameters. For example, method someMethod (line 836-841) creates an instance of concept SavingsAccount and stores the new reference in its local variable (line 838). Then this reference is used to call a method of this concept (line 839). In order to execute the invoked method it is necessary as usual to resolve its reference. However, to avoid repeated resolutions of individual segments, this procedure starts from the first segment and then resolves all the next segments as described above by storing the resolved direct reference on the context stack. Since the very first segment is of concept Root it is already a direct reference and needs not to be resolved. The next segment is of concept Account and this reference is resolved by its continuation method. The third segment is resolved by the continuation method of concept SavingsAccount. All the resolved segments are pushed on the context stack. Finally, when all segments are resolved, the target method can be called. Notice that now all the constituents of the object can be directly accessed because their references are stored in the context stack. In particular, lines 831-832 are executed immediately without reference resolution. The whole target method is wrapped into the resolution procedure consisting of the continuation methods. Its output is shown in lines 843-847. If context stack was not used then each access to the parent object from a child would be wrapped into the resolution procedure of concept Account.

TABLE 8
Context resolution

| | |
|---|---|
| 801 | concept Account in Root |
| 802 | reference { |
| 803 | ... // As in Tables 7 |
| 804 | void continue( ) { |
| 805 | print(“> Account: Start resolution”); |
| 806 | Root root = resolve(this); |
| 807 | root.continue( ); |
| 808 | print(“< Account: End resolution”); |
| 809 | } |
| 810 | } |
| 811 | class { |
| 812 | ... // Members can be accessed from child concepts |
| 813 | int contextField; |
| 814 | void contextMethod( ) { ... } |
| 815 | } |
| 816 | |
| 817 | concept SavingsAccount in Account |
| 818 | reference { |
| 819 | ... // As in Tables 7 |
| 820 | void continue( ) { |
| 821 | print(“ > SavingsAccount: Start resolution”); |
| 822 | Root root = resolve(this); |
| 823 | root.continue( ); |
| 824 | print(“ < SavingsAccount: End resolution”); |
| 825 | } |
| 826 | } |
| 827 | class { |
| 828 | ... // As in Tables 7 |
| 829 | void doSomething( ) { |
| 830 | print(“ *** Target object method”); |
| 831 | super.contextMethod( ); // No resolution is needed |
| 832 | super.contextField = 3; // No resolution is needed |
| 833 | } |
| 834 | } |
| 835 | |
| 836 | void someMethod( ) { |
| 837 | ... |
| 838 | SavingsAccount savingsAccount = new SavingsAccount ( ); |
| 839 | savingsAccount.doSomething( ); |
| 840 | ... |
| 841 | } |
| 842 | |
| 843 | $ > Account: Start resolution |
| 844 | $ > SavingsAccount: Start resolution |
| 845 | $ *** Target object method |
| 846 | $ < SavingsAccount: End resolution |
| 847 | $ < Account: End resolution |

### Uses of Indirect Representation and Access

In this section we describe how the proposed mechanism for indirect representation and access can be used. The main idea is that instead of the conventional classes we use concepts which are pairs consisting of one object class and one reference class. Instances of the reference class are passed-by-value and therefore part of information is represented directly. Accordingly, when describing new object types it is possible to divide all their properties on two parts: those passed-by-values and those passed-by-references. The former will be part of the reference class and the latter will be part of the object class. In particular, frequently used constant fields can be part of the reference class while common information used by different processes should be defined as part of the object class. An example of such a separation for bank accounts is shown in Table 4.

However, the main purpose of concepts consists in defining a virtual hierarchical address system. In this case it is assumed that a reference is not simply a number of fields passed-by-value but rather an indirect representation of some object. In other words, fields of the reference class are interpreted as an object identifier. For example, in the reference class shown in Table 4 the first field (line 403) is used to identify account objects while other three fields are used to pass some information about the account by value. In this way the programmer can define different formats of identifiers (addresses) for different classes of objects. Such custom addresses do not provide direct access to the represented objects because the fields of the reference are set according to some convention established by the programmer. In order to read/write object fields or to call its methods it is necessary to resolve its reference by translating its fields into a direct reference. This task is performed by the continuation method automatically and transparently. The programmer uses objects as usual by storing their references and calling their methods. All the intermediate processing is executed behind the scenes.

In order to demonstrate advantages provided by the proposed method let us assume that there is concept Account (for example, as defined in Table 4) which implements some logic of account management in its object class and some logic of account identification and access in its reference class. Already here we see one advantage. Namely, we managed to separate two concerns: business methods on one hand and object representation and access on the other hand. Indeed, the standards for account identification may change and it is very important to have this concern separated from the main logic of account management. And vice versa, if something changes in the main business logic, say, how accounts are credited, this does not influence the logic of account identification and access because they are defined in the separate classes of one concept.

Let us now assume that accounts are stored in some persistent storage. For example, it could be a database where one table stores all the accounts. Here again we have a two-fold goal: on one hand it is necessary to inject some intermediate behaviour for loading account objects before they can be used and on the other hand it is necessary to retain transparent access to the account objects as if they were represented directly. For example, getting an account balance given its reference has to be done in one line of code: ‘account.getBalance( )’. All the intermediate operations like loading this account state from the database or from cache have to be executed automatically and transparently. If we were using account class in the conventional way then each invocation of its business method would be executed directly without any intermediate actions because objects in OOP are represented by system default references. In particular, in prior art a call of method ‘account.getBalance( )’ would directly result in execution of its first line of code because this object normally resides in memory. If this account is stored persistently in a database then its state has to be explicitly reconstructed in main memory before it can be accessed. The traditional approach consists in loading the account from the persistent storage before it needs to be accessed and storing back its new state when it is not needed anymore. And this has to be made explicitly each time we need to access any account.

This invention allows us to perform access transparently so that all intermediate operations are performed behind the scenes. The use of objects in this case is separated from the underlying mechanism of object representation and access. For this purpose we can define a parent concept, called Persistent, which implements all the necessary logic of representation and access to persistent objects. Then target classes are included in this concept and all their objects will automatically get persistence. After that we can use our account objects (as well as objects of other concepts included in concept Persistent) as usual by calling their business methods. However, the presence of the parent concept Persistent means the existence of an additional level of indirection where some intermediate operations are executed automatically as accounts are being accessed. Thus this new approach allows us to manipulate target objects as if they were normal objects in OOP and at the same time to automatically inject the necessary intermediate actions implementing some logic of indirect representation and access.

One possible implementation of concept Persistent is shown in Table 9. The idea is that bank accounts exist within some bank and hence for complete identification it is necessary to have an addition high segment for each account. This segment represents one bank using bank name. Concept Persistent has one static field (line 902) which stores a mapping from the space of bank identifiers (bank names) to the space of the corresponding objects of this concept. In other words, this field is used to store a mapping from references of this concept to objects of this concept (represented by direct references). This example does not show how this mapping is populated but it is assumed that for each new bank there is a reference-object pair in this field. For example, we could initialize this field when this program starts or when a bank is being accessed. This map could contain a record consisting of the following two values: <“Citibank”, 0xabcd1234>. The first value is the bank name (an indirect reference) while the second field is a direct reference to this bank object (an instance of this concept object class).

It is assumed that the bank name will be the first segment of any bank account complex reference. The structure and functions of this segment are described by the reference class of concept Persistent (lines 903-911). It has one field for the bank name (line 904) and the continuation method (lines 905-910) which is called automatically whenever it is necessary to resolve this segment. The continuation method starts and ends with two diagnostic messages (lines 906 and 909, respectively). Its main function consists in resolving the bank name into the corresponding object (line 907) and then using the resolved direct reference to proceed (line 908). Line 908 is very important for the program compiler because at this point the resolved reference could be pushed on the context stack if it is maintained and then used to access the resolved object of this concept.

The object class of concept Persistent has one field for storing a connection to the database where this bank accounts are stored (line 913) and one field for account objects cache (line 914). The connection is used to load and store accounts in the database. The cache stores triples consisting of account number (string), account object (direct reference) and account access count (integer). For example, such a triple could look as follows: <“123456789”, 0xdcba4321, 5>. This means that the object with the key “123456789” and direct reference 0xdcba4321 is currently being accessed by 5 processes. When an account is going to be accessed its access count is incremented. And when this access is finished the access count for this object is decremented. If an object is not currently accessed then its access count is 0. This is part of the intermediate logic of representation and access which is modularized in the object class but will be injected automatically into other modules as described below. The object class defines two convenience methods for resolving text strings interpreted as primary keys into objects in memory (lines 915-923) and unresolving them (lines 924-930). These methods can be then used from child objects. The resolution method tries to find the indicated object in the cache (line 916). If it cannot be found then it loads it from the database (line 918) and adds it to the cache (line 919). Finally it increments the access count for this object (921) and returns the resolved reference (line 922). Method unresolved executes these operations in the opposite direction. It decrements the access count for the specified object (line 925) and if this object is not used anymore the method removes it from the cache (line 927) and stores its state in the database (line 928). This logic of access is only an example and could be implemented in a more complex way. For example, we could restrict the number of accessing processes or the size of the cache. Here it is important only that these intermediate functions are written in one place and then can be automatically used for different target objects.

Let us now again consider an example of concept Account shown in Table 6. In order to make objects of this concept persistent we simply include it in concept Persistent as follows: ‘concept Account in Persistent’ (line 933 in Table 9). Such an inclusion effectively means that all account objects will be represented by bank name as the first segment and bank number as the second segment. Account numbers are resolved by means of their continuation method (lines 604-610) but this resolution is carried out in the context of one object of concept Persistent. The continuation method uses two convenience methods resolve (line 606) and unresolve (line 608) defined in the parent concept Persistent as described above. It is assume that the two invocations (lines 606 and 608) refer to the methods of their parent concept, i.e., they can be written using keyword ‘super’ as follows: ‘super.resolve(number)’ and ‘super.unresolve(number)’.

TABLE 9
An example of persistent concept

| | |
|---|---|
| 901 | concept Persistent in Root { |
| 902 | static Map banks = new Map( ); |
| 903 | reference { |
| 904 | String bank; // Bank identifier |
| 905 | void continue( ) { |
| 906 | print(“> Start resolving bank ” + bank); |
| 907 | Root root banks.get(bank); |
| 908 | root.continue( ); |
| 909 | print(“< End resolving bank ”+bank); |
| 910 | } |
| 911 | } |
| 912 | class { |
| 913 | Connection dbConnection; |
| 914 | Map cache = new Map( ); // Key-reference-accessCount |
| 915 | Root resolve(String key) { |
| 916 | Root root = cache.get(key); |
| 917 | if(root==null) { |
| 918 | root = dbConnection.load(key); |
| 919 | cache.add(key, root, 0); |
| 920 | } |
| 921 | cache.incrementAccessCount(key); |
| 922 | return root; |
| 923 | } |
| 924 | void unresolve(String key) { |
| 925 | cache.decrementAccessCount(key); |
| 926 | if(cache.getAccessCount(key) == 0) { |
| 927 | Root root = cache.remove(key); |
| 928 | dbConnection.store(key, root); |
| 929 | } |
| 930 | } |
| 931 | } |
| 932 | |
| 933 | concept Account in Persistent // As in Table 6 |
| 934 | |
| 935 | $ > Start resolving bank Citibank |
| 936 | $ > Start resolving account 123456789 |
| 937 | $ *** Execute object method |
| 938 | $ < End resolving account 123456789 |
| 939 | $ < End resolving account Citibank |

The result of the inclusion of concept Account in concept Persistent is that we can use account objects as usual by calling their methods and all the necessary intermediate procedures for managing persistent objects are injected automatically. So we have the complete illusion of direct access to indirectly represented objects. For example, if we apply a method to an account object (line 622) then this results in the output shown at the end of Table 9 (lines 935-939). Notice that the target method is wrapped into two intermediate methods. (Here it is assumed that context stack is used and hence the reference is resolved only one time.) The first one resolves the bank segment of the complex reference while the second method resolves the account number segment. Such account objects can be passed and stored anywhere because they do not store direct (native) references. For example, we can store an account in a field of some object and then serialize this object and store its state in a database or in file. If this object will be desterilized then its field pointing to the account will be still valid because it has only indirect reference, i.e., it stores actually bank name and account number. In prior art if an object reference is stored in a database or file then it is not possible to use it after loading back in memory because it normally points to an arbitrary location in memory.

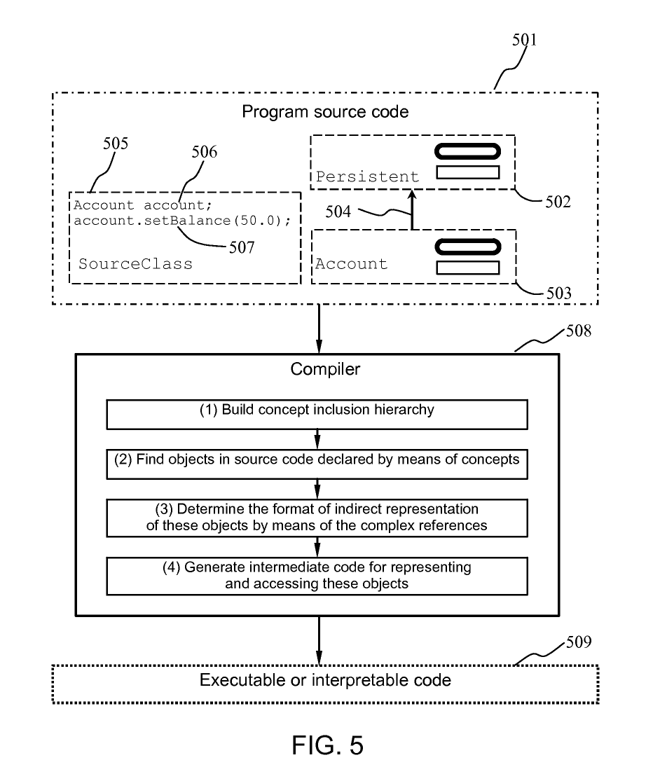

FIG. 5 is a flowchart depicting the process of compilation of a concept-oriented program. The program source code 501 consists of a concept definition 502 and the target concept 503. The target concept 503 is included in the parent concept 502 by means of the syntactically identifiable inclusion relation 504. This effectively means that objects of this target concept will be represented and accessed indirectly via its parent concepts. The program source code also includes places where objects of the target concept are used. The source class 505 has a declaration of the variable 506 and the target business method call applied to this variable 507. Notice however, that since this variable is declared using a concept as its type it will contain a complex reference as a representative of the target object. Compiler 508 receives this source code and performs the following operations in order to convert it into the executable or interpretable form. It identifies all concept declarations and builds an inclusion hierarchy of concepts (1). Here the compiler also adds the root of this concept hierarchy, references of which provide means for direct representation and access. Then the compiler finds objects (variables, method parameters, class fields, return values etc.) with classes or concepts included in other concepts (2). For each such object the compiler finds the format of its complex reference depending on the position of this target class in the inclusion hierarchy (3). Then the compiler generates an appropriate code for representing and accessing these objects taking into account that they are represented indirectly by means of their complex references (4). In particular, this code includes operations for maintaining the context stack and routines for reference resolution. Finally the generated code is stored in the target format 509 that can be executed, interpreted or used as a library. Notice that the generated code can be either concept-free or include instructions that can be executed only in a concept-aware run-time environment.

### CONCLUSIONS

The present invention proposes a new method for indirect representation and access in an object-oriented programming language. This method is based on using a new programming language construct, called concept, which is a combination of one reference class and one object class with instances called references and objects, respectively. References are passed-by-value and objects are passed-by-reference. Thus using one programming construct it is possible to describe two types of functionality: the conventional business methods described in object classes and intermediate functions executed behind the scenes when program object are being accessed described in reference classes. In order to transparently resolve references this invention proposes to use the continuation method defined in the reference class. This method is called automatically whenever the object represented by this reference has to be accessed. The continuation method resolves this reference into the system default reference which is then used to directly access the target object.

Concept inclusion relation allows the programmer to define the format of complex references consisting of a number of segments. Each segment of a complex reference is an instance of one reference class along one path in the concept inclusion hierarchy (an access sequence). In order to access an object represented by such a reference it is necessary to resolve all its segments using their continuation methods. In order to optimize access to parent objects their resolved references can be stored on the context stack. In this case the access procedure starts from resolving the very first (high) segment and then resolves next segments. When the last segment is resolved and its reference is pushed on top of the context stack the target object can be directly accessed.

A concept-oriented program uses concepts instead of classes. In particular, variables, parameters, fields, return values and other elements are declared with concepts as their type rather than classes. When the compiler encounters a concept as a type it needs to find the reference format for this object which then determines how this object will be represented and accessed. In prior art programming languages it is normally some system default format like memory handle or Java reference. In the described method this format is a complex reference with the structure and behaviour defined in this program. Such objects are then used as usual by calling their methods and reading/writing fields. However, in contrast to prior art languages, each such access will trigger an additional intermediate functionality described in its parent concepts. In particular, methods of the reference class will intercept accesses to methods of the object class. Thus, by using concepts, the programmer can reduce program redundancy by removing identical code fragments distributed all over the program. This method makes the process of code maintenance easier, the program code more readable and the program itself more reliable.

This new approach to programming can be applied to very different complex problems where objects have to be represented and access indirectly. This includes access control and interception, security and object protection, persistence, debugging, tracing and logging, memory and life-cycle management, object containers, remote objects, distributed computing, protocol stacks and many other technologies and problems. In all these and other applications it is necessary to ensure some logic of representation and access but on the other hand retain the illusion of direct access. This invention allows the programmer to solve this and other problems.

What is claimed is:

1. A method for indirect representation and access in an object-oriented programming language, the method comprising: defining one or more concepts, the concept combining in one programming construct two classes:
a) an object class with instances passed-by-reference, and
b) a reference class with instances passed-by-value and indirectly representing objects.

2. The method of claim 1 wherein target program objects are represented by means of their complex references further comprising the steps of:
a) specifying for each concept in the program one parent concept,
b) determining for the target object an access sequence consisting of concepts, wherein each concept in the sequence is the parent concept for the next concept, and the last concept in the sequence is the type of the target object,
c) finding the format of the complex reference as a sequence of reference segments, each segment having a reference class belonging to one concept in the found access sequence.

3. The method of claim 2 wherein instances of the object class of a concept are indirectly represented and accessed by means of instances of the reference class of the concept further comprising the steps of:
a) defining a continuation method of the reference class intended to resolve this reference into a system default reference representing this object directly,
b) applying said continuation method automatically to its reference when it is necessary to access the indirectly represented object of this concept.

4. The method of claim 3 wherein a context stack is used, comprising the steps of:
a) resolving reference segments of the complex reference one after another starting from the first segment and ending with the last segment using the continuation methods of their reference classes,
b) pushing each resolved reference segment onto the top of the context stack,
c) using resolved references stored in the context stack to directly access the parent objects.

5. A computer-readable medium storing instructions that when executed by a computer cause the computer to perform the method of claim 1.

6. A computer-readable medium storing instructions that when executed by a computer cause the computer to perform the method of claim 2.

7. A computer-readable medium storing instructions that when executed by a computer cause the computer to perform the method of claim 3.

8. A computer-readable medium storing instructions that when executed by a computer cause the computer to perform the method of claim 4.

9. A computer program comprising instructions that when executed by a computer cause the computer to perform the method of claim 1.

10. A computer program comprising instructions that when executed by a computer cause the computer to perform the method of claim 2.

11. A computer program comprising instructions that when executed by a computer cause the computer to perform the method of claim 3.

12. A computer program comprising instructions that when executed by a computer cause the computer to perform the method of claim 4.

13. A computer system having a processor, a memory and an operating environment, the computer system operable to execute the method of claim 1.

14. A computer system having a processor, a memory and an operating environment, the computer system operable to execute the method of claim 2.

15. A computer system having a processor, a memory and an operating environment, the computer system operable to execute the method of claim 3.

16. A computer system having a processor, a memory and an operating environment, the computer system operable to execute the method of claim 4.
